(19) United States
(12) Patent Application Publication
(10) Pub. No.: US 2009/0147366 A1
(43) Pub. Date: Jun. 11, 2009

(54) Winged eyecup for optical devices

(76) Inventor: Mark S. Farr, Monah, UT (US)

Correspondence Address: Mark;Farr, PO Box 265, Mona, UT, 84645, US

(21) Appl. No.: 11/953,125

(22) Filed: Dec. 10, 2007

(51) Int. Cl. G02B 23/16

(52) U.S. Cl. 359/611; 359/600

(57) ABSTRACT

An adjustable winged eyecup allows the user to apply it to many makes and models of existing and new optics. The winged eye cup is essential for eliminating light and elements while using an optical device such as a binocular or monocular. The winged eyecup can also provide a constant eye relief for the optical device. It is designed to be removable and the same winged eyecup can be applied to many different makes and models of optical devices.

### BACKGROUND OF THE INVENTION

1. Field of Invention

The present invention relates to an apparatus for enhancing viewing experience while using optical devices. In particularly it pertains to an easy to apply winged eyecup in conjunction with the eyepiece of the optical device. The winged eyecup blocks glare, rain, wind, dust, etc from irritating the eye while using the optical device.

Some binocular manufactures create a winged eyecup for their binoculars. These are very limited and must be manufactured for each type of binocular. It has been found that a need remains for an aftermarket adjustable winged eyecup that user can easily apply and remove. This eyecup adjusts to many makes and models of optics and due to the design allows eyecup to maintain a constant distance between the uses eye and optical device ensuring consistent eye relief.

2. Description of Prior Art

Eyecups used in conjunction with optical devices are used in prior art. An Example of such device may be found in U.S. Pat. No. 5,225,932, Eyecup insert for night vision goggles. U.S. Pat. No. 5,225,932 is a eyecup for night vision goggles. This device is designed to block light escaping from the optical device and does not address the need for blocking external light entering the eye or solve the ability to attach to irregular shaped, and varying sizes of eye pieces. It also requires the night vision goggles to have a specific annular channel to insure the snap fit of the eyecup. This requires complicated manufacturing process. The Bellows of the device also fails to maintain a consistent distance from the optical device for eye relief.

U.S. Pat. No. 6,450,651, Anti-glare device for Objective lenses, is for the objective lens of an optical device and not designed for blocking glare and elements from the users eye. This device does not address the need for a seal between the users eye and optical device.

### BRIEF SUMMARY OF THE INVENTION

An adjustable winged eyecup blocks all light from entering the optical device except through the objective end of the device. It does this by create a seal between the optical device and the users eye. The winged eyecup blocks unwanted glare and debris from entering the eye. The winged eyecup can also provide a constant eye relief for the optical device. It is designed to be removable and the same winged eyecup can be applied to many different makes and models and shapes of optical devices.

### OBJECTS OF THE INVENTION

The principal object of the present invention is to provide a winged eyecup that can fit many makes and models of optics that the user can easily apply or remove to the eyepiece of the optics.

Another object of the present invention is to provide an eyecup that limits light from entering the eye except through the objective end of the optical device. This allows the eye to focus more clearly without glare.

Yet another object of the present invention is to protect the eye from the elements such as wind, rain and dust and snow.

Yet another object of the present invention is to allow for adjustment for eye relief for the optical device and can be positioned on the eye piece to hold the eye at a constant distance from the lens ensuring a full field of view from the optical device.

Yet another object of the present invention is for the winged eyecup to protect the eyepiece of the optics from dirt, debris and damage from contact.

Other features are to provide an eyecup that is easily and economically produced.

### BRIEF DESCRIPTION OF THE SEVERAL VIEWS OF THE DRAWING

FIG. 1 is a side view of a winged eyecup of the present invention.

FIG. 2 is a top view of a winged eyecup of the present invention;

FIG. 3 is a side view of a winged eyecup with the fasteners attached of the present invention.

FIG. 4 is a top view of a winged eyecup with the fasteners attached of the present invention and

FIG. 5 is a perspective view of a typical working view of the present invention attached to a pair of binoculars.

### DETAILED DESCRIPTION OF THE INVENTION

Referring now to the present invention in more detail, in FIG. 1 there is shown an adjustable winged eyecup (10). The winged eyecup (10) is made up of three basic areas; First the wing (12) second the band (14) and third the fastener (16). The wing's (12) primary purpose is to create a seal to the users eye and block light, and elements such as wind, rain, and snow entering into the eye. The wing must be sufficiently large enough to surround user's eye. The band (14) attaches the wing (12) to an optical device and allows the user to apply the eyecup (10) to a wide range of optical devices. The band (14) in conjunction with the fastener (16) securely holds the eyecup in place and allows the user to adjust the length of eye relief needed for the optical device. The width of the band (14) allows for greater eye relief adjustment and provides protection for the eyepiece. The fastener (16) is designed to be easily attached and removed but when attached it firmly secures the eyecup to the optical device.

In more detail, the winged eyecup (10), when in use, will be positioned on the binocular (20) (FIG. 5) to encircle the eyepiece of the binocular and when raised to the users face the winged eyecup (10) will encircle the user's eyes. The winged eyecup (10) will be adjusted by the user to block light from entering into the eye except through the objective lens of the optical device . The eyecup (10) may also be re-positioned on the optical eye piece (18) to account for eye relief. This allows the eye to be held at a constant distance away from the eye allowing for full field of view of the optical device. Optical devices have varying eye relief values.

The winged eyecup (10) can be made of various different materials. The material shown for both the wing (12) and band (14) is neoprene, but these could be made out of any semi-rigid material. The fastener (16) can also be of different connecting technologies. The fastening device shown is Velcro.

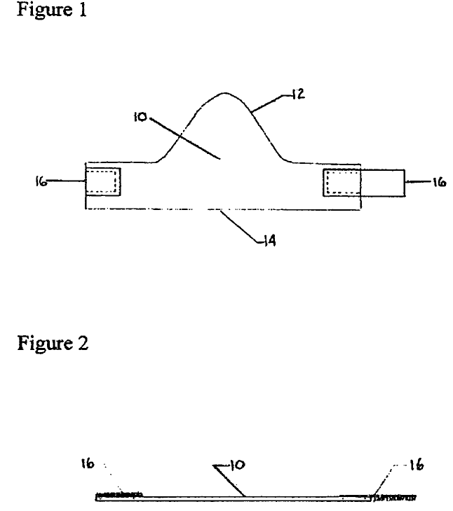

In FIG. 2 a top view is shown of a winged eyecup (10) and gives a representation of the thickness of material used. The material used must be flexible enough as to be positioned around the eye piece, but rigid enough to hold its shape against the user's eye. It must also be comfortable for the user when positioned against the user's face. It also shows the fastener used (16).

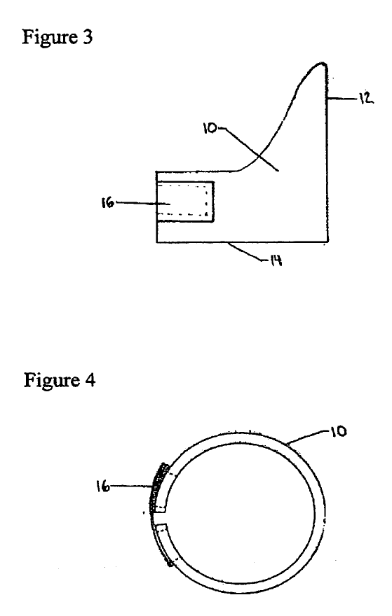

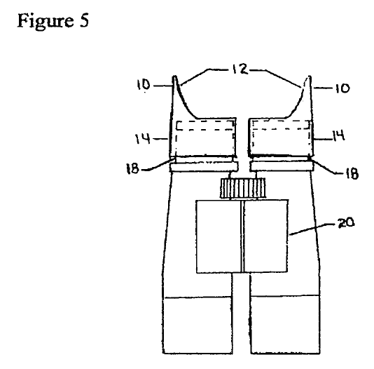

In FIGS. 3 and 4 you see both a side view FIG. 3 and top view FIG. 4 of a winged eyecup (10) with the fastener (16) in place. It shows how the device would be fitted around a circular eye piece (18). It shows how the fastening device (16) holds the band (14) together.

In FIG. 5 a perspective view of the winged eyecup (10) is shown attached to a binocular (20). The material is wrapped around the eyepiece (18) of the optical device (20) and is held in place by a fastener (16). This method allows for eyepieces of different diameters, shapes, and sizes to be fitted from a single winged eyecup (10). For each eyepiece (18) a winged eyecup (10) is present. For example a binocular (10) has two eyepieces (18) so two winged eyecups (10) would be applied. On a monocular a single eyecup (10) would be present.

The advantages of the present invention include an adjustable winged eyecup that the consumer can easily apply to a wide range of optics. The present invention does not require the manufacture to supply the eyecup and there for can be fitted to existing optics or new optics. There are winged eyecups available for a very few binoculars but these are not interchangeable and are not designed to be applied by the user. The present invention gives the user the ability to apply and remove the winged eyecup to wide range of optics. The Present invention also protects the eyepiece of the optical device and provides an eye relief adjustment that the existing eyecups do not provide.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. It is claimed that a winged eyecup comprising a protective band of semi-ridged material surrounds the eyepiece of an optical device and the winged eyecup snuggly surrounds the users eye forming a seal between the user and the optical device allowing light to enter the optical device only from the objective side.

2. A winged eyecup as in claim 1, further claims can be easily removed and reapplied to a wide variety of shapes, and sizes of eyepieces on many optical devices.

3. (canceled)

4. (canceled)

5. A winged eyecup as in claim 1, further claims provides an adjustable eye relief for the optical device by holding the eye at an optimal distance from the optical lens

6. A winged eyecup as in claim 1, further claims it blocks lateral light from entering into the eye and blocking glare and reducing eye strain allowing the optical device to perform better in both bright sun and low light conditions.

7. (canceled)
